(19) United States
(12) Patent Application Publication
(10) Pub. No.: US 2011/0200213 A1
(43) Pub. Date: Aug. 18, 2011

(54) HEARING AID WITH AN ACCELEROMETER-BASED USER INPUT

(75) Inventor: John Michael Page Knox, Austin, TX (US)

(73) Assignee: AUDIOTONIQ, INC., Austin, TX (US)

(21) Appl. No.: 13/021,540

(22) Filed: Feb. 4, 2011

Related U.S. Application Data
(60) Provisional application No. 61/304,281, filed on Feb. 12, 2010.

(51) Int. Cl. H04R 25/00

(52) U.S. Cl. 381/314

(57) ABSTRACT

A hearing aid includes a memory configured to store current configuration data and an accelerometer to convert mechanical motion into a signal representing mechanical motion. The hearing aid further includes a logic circuit coupled to the accelerometer to receive the signal and to selectively update the configuration data based on the signal.

### CROSS-REFERENCE TO RELATED APPLICATION(S)

This application is a non-provisional application of and claims priority from U.S. Provisional Patent Application No. 61/304,281 filed on Feb. 12, 2010 and entitled “Hearing Aid with an Accelerometer-Based User Interface,” which is incorporated herein by reference in its entirety.

### FIELD

This disclosure relates generally to hearing aids, and more particularly to systems and methods of providing user inputs using an accelerometer.

### BACKGROUND

Hearing deficiencies can range from partial hearing impairment to complete hearing loss. Often, an individual's hearing ability varies across the range of audible sound frequencies, and many individuals have hearing impairment with respect to only select acoustic frequencies. For example, an individual's hearing loss may be greater at higher frequencies than at lower frequencies.

Hearing aids have been developed to alleviate the effects of hearing losses in individuals. In instances where the individual's hearing loss varies across frequencies, such hearing aids can be tuned by an audiologist, for example, to compensate for the unique variations of the individual's hearing loss.

Conventionally, hearing aids range from ear pieces configured to amplify sounds to configurable hearing devices offering adjustable operational parameters that can be configured by a hearing specialist to enhance the performance of the hearing aid. Parameters, such as volume or tone, often can be easily adjusted, and many hearing aids allow the individual users to adjust these parameters.

However, many other parameters and response characteristics, including signal amplitude and gain characteristics, and parameters associated with signal processing algorithms, including signal frequency transforms, cannot be adjusted by the user. Instead, a hearing health professional typically takes measurements using calibrated and specialized equipment to assess an individual's hearing capabilities in a variety of sound environments, and then adjusts the hearing aid based on the calibrated measurements. Subsequent adjustments to the hearing aid can require a second exam and further calibration by the hearing health professional, which can be costly and time intensive. In some instances, the hearing health professional may create multiple hearing aid profiles for the user for use in different sound environments based on the users hearing profile.

Unfortunately, such hearing aids often do not allow user selection of the hearing aid profiles. Further, to the extent that such devices permit user adjustment of volume and tone, the interface for making such adjustments can be difficult to access. Sometimes, such adjustments require the user to remove the hearing aid in order to access the controls. Removal of the hearing aid may be embarrassing to a user, and many user's may simply choose to experience poor hearing rather than make necessary adjustments to the hearing aid in a public setting.

### BRIEF DESCRIPTION OF THE DRAWINGS

FIG. 1 is a block diagram of a hearing aid including an accelerometer;

FIG. 2 is a flow diagram of a method of configuring settings of a hearing aid using an accelerometer; and

FIG. 3 is a block diagram of a system including a computing device and a hearing aid with an accelerometer.

In the following description, the use of the same reference numerals in different drawings indicates similar or identical items.

### DETAILED DESCRIPTION OF ILLUSTRATIVE EMBODIMENTS

Embodiments of systems and methods are described below that provide a motion-based user input for adjusting parameters associated with a hearing aid. In particular, the hearing aid includes an accelerometer configured to generate signals proportional to an acceleration of the hearing aid relative to one or more axes, which signals can represent user input or user feedback with respect to one or more selectable configuration options. For example, the hearing aid may be configured to present an audio menu to the user, providing one or more options that can be selected by the user to configure performance parameters of the hearing aid. The hearing aid uses the accelerometer to detect the user's head movements, indicating user input relative to the one or more options and configures the hearing aid parameters based on a selection related to the user input.

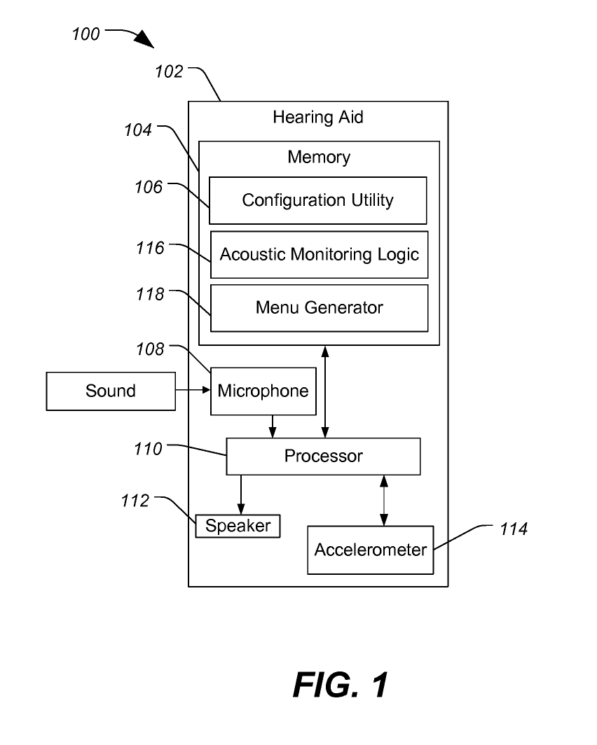

FIG. 1 is a block diagram of a hearing aid 102 adapted to utilize an accelerometer 114 for detecting user input. Hearing aid 102 includes a microphone 108 configured to receive environmental noise or sounds and to convert the sounds into sound-related signals. In an embodiment, hearing aid 102 includes one or more directional microphones. Microphone 108 provides the electrical signals to signal processor 110, which processes the electrical signals according to a hearing aid profile associated with the user to shape the sound-related electrical signals to produce a modulated output signal that is customized to a user's particular hearing loss. Processor 110 is configured to provide the modulated output signal to a speaker 112, which is adapted to reproduce the modulated output signal as an audible sound at or within an ear canal of the user.

Hearing aid 102 includes a memory 104 connected to processor 110. Memory 104 stores configuration utility instructions 106 that, when executed, cause processor 110 to provide a list of audible menu options from which a user may select. Further, memory 104 stores instructions executable by processor 110 to interpret electrical or digital signals from accelerometer 114 relative to such menu options. Further, configuration utility instructions 106 may include instructions executable by processor 110 to update settings, parameters, or hearing aid profiles associated with the hearing aid 102, which settings, parameters, or hearing aid profiles determine the shaping applied to the signals to produce the modulated output signal. Further, memory 104 can include acoustic monitoring logic 116 that is executable by processor 110 to detect a change in the user's acoustic environment. Additionally, memory 104 may include menu generation logic 118 that is executable by processor 110 to generate an audio menu from which the user can configure settings associated with the hearing aid. Examples of such settings include volume, tone, and/or hearing aid profiles. Memory 104 may also include configuration settings, including microphone directionality settings as well as hearing aid profile-related settings.

In one embodiment, the user may signal hearing aid 102 to activate the configuration utility 106 to adjust the operational settings of hearing aid 102 by moving his or her head in a particular pattern. Accelerometer 114 generates electrical signals proportional to the direction and acceleration of the user's movements, which signals are detectable by to initiate the configuration process. Alternatively, the user may signal the hearing aid 102 by pressing a button, by speaking a voice command, or through some other mechanism. In another example, hearing aid 102 may detect a change in the acoustic environment based on acoustic monitoring logic 116 and may initiate the configuration process in response to detecting the change. In one instance, the user may activate the configuration utility by holding his or her head in a pre-determined position for a pre-determined length of time. In a particular embodiment, the accelerometer is a tri-axial accelerometer.

Based on the trigger, processor 110 executes the configuration utility instructions 106. The configuration utility instructions 106 prepare hearing aid 102 to receive user input. In some instances, such as where accelerometer 114 is not used to initiate the configuration utility instructions 106, configuration utility instructions 106 may prepare hearing aid 102 by activating accelerometer 114, which can be used to receive input from the user. In this instance, by disabling accelerometer 114 when not in use, power consumption of hearing aid 102 can be lowered, extending battery life.

In one embodiment, configuration utility instructions 106 cause processor 110 to execute menu generation instructions 118 to produce an audio menu, which can be audibly produced for the user by speaker 112. The audio menu presents the user with selectable options for configuring hearing aid 102 together with instructions for selecting a particular option. In one example, the audio menu may indicate to the user “To select option A, please tilt your head to the left; to select option B, please tilt your head to the right.” Either while playing the menu or after playing the menu, processor 110 monitors signals from accelerometer 114 to detect mechanical movement of the user (such as a nod, a head shake, a tilt, etc.) indicating a selection of a particular menu item or identifying one of several menu items.

In an alternative embodiment, configuration utility instructions 106 may be programmed to detect pre-defined movements, which correspond to preprogrammed configuration settings for hearing aid 102. For example, a rapid movement or shake of the user's head to the left could be pre-programmed to incrementally increase a volume setting and a similar movement to the right could be pre-programmed to incrementally decrease the volume setting. Alternatively, a combination of movements could be used to activate a sound canceling algorithm.

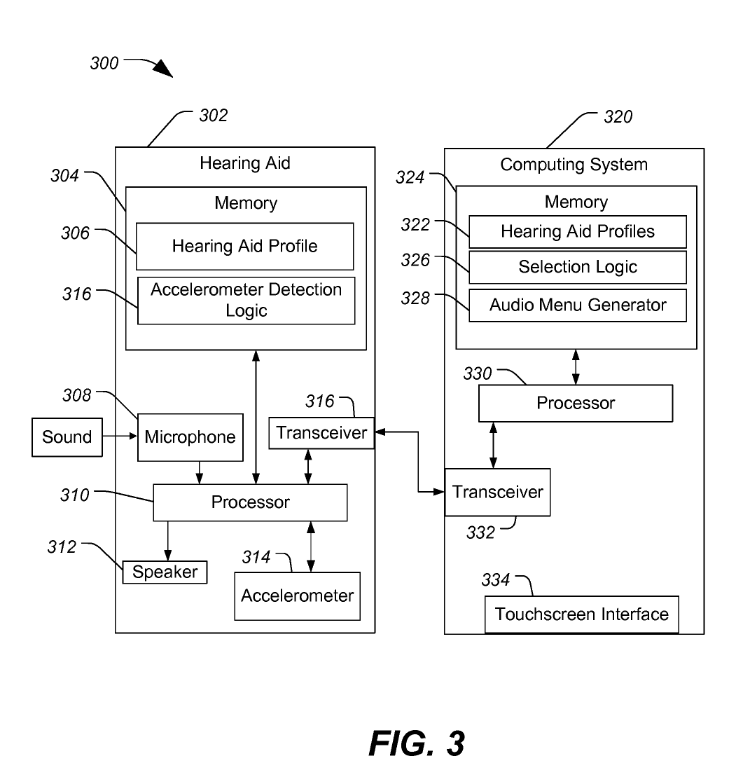

In an example, menu generation instructions 118 may be executed by processor 110 to present a list of hearing aid profiles from which a user may select. The hearing aid profiles may be identified from hearing aid profiles stored in memory 104 or may be provided by a remote device, such as a computing system (such as that depicted in FIG. 3). In another example, the menu generation instructions 118 may present a list of adjustment options (such as volume, tone, filtering, etc.) from which a user may select by moving his/her head in a particular fashion. Such movements can be converted into electrical signals proportional to the direction and acceleration of the movement, which electrical signals can be interpreted as user inputs or user selections. In this manner, a user can adjust his/her hearing aid settings without touching the hearing aid 102 and without having to remove the hearing aid.

While in the above-example, a processor 110 accesses a memory 104 to provide the audio menu functionality, it should be appreciated that a separate logic circuit may be provided for monitoring the accelerometer 114 and for communicating accelerometer 114 signals through a transceiver to a remote computing device (such as that depicted in FIG. 3).

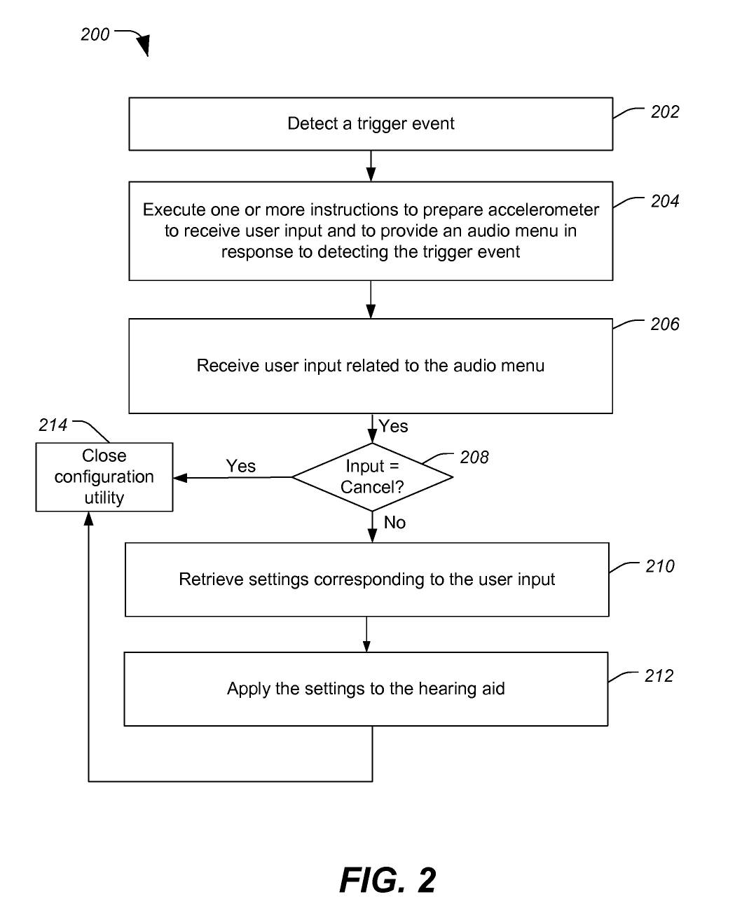

FIG. 2 is a flow diagram of a method 200 of configuring settings of a hearing aid using an accelerometer. At 202, processor 110 detects a trigger event. The trigger event can be a user selection through a remote computing device (such as the computing device depicted in FIG. 3 below) or user selection of a button on the hearing aid. Alternatively, the trigger can be a particular movement or position detected based on signals from the accelerometer. In another embodiment, the trigger may be a spoken command or voice input received by the microphone.

Advancing to 204, processor 110 executes one or more instructions to prepare accelerometer 114 to receive user input and to provide an audio menu in response to detecting the trigger event. The audio menu may be generated by processor 110 using menu generator instructions 118. Alternatively, the audio menu may be pre-recorded and stored in memory 104.

Proceeding to 206, hearing aid 102 receives user input related to the audio menu. The user input is received as a signal from accelerometer 114, where signal represents mechanical motion of the hearing aid. The timing or direction of such motion may be used to indicate a particular menu option. For example, the audio menu may request that the user nod or move his or her head rapidly one time when a desired menu option is played. Alternatively, the menu may specify that the user should “Nod once for option one,” “Nod twice for option two,” etc. In an alternative embodiment, the menu may state “turn your head to the right for option one, to the left for option 2, or look up for option 3.” Other relative movements may also be used. One of the menu options may include an option to cancel the configuration process. At 208, if the user input indicates cancellation, the method 200 proceeds to 214 and the configuration utility is closed.

Otherwise, at 208, if the input does not indicate cancellation, method 200 proceeds to 210 and processor 110 retrieves settings corresponding to the user input. In one embodiment, the settings may be stored as a pre-configured hearing aid profile in memory 104. In another embodiment, the user input may include an adjustment to a setting, such as a volume or tone adjustment. Continuing to 212, processor 110 applies the configuration changes to hearing aid 102, and then advances to 214 and the configuration utility is closed. Application of the changes to hearing aid 102 includes applying the adjustment to a hearing aid profile applied by processor 110 to sounds received from microphone 108 to produce modulated output signals that compensate for the user's particular hearing deficiency.

While the above-examples have described an embodiment of a hearing aid configured to produce the audio menu, it should be appreciated that the hearing aid may simply play the menu, which can be provided by a computing device, such as a cell phone, a personal digital assistant, a portable computer, or some other computing device. An example of such a system is described below with respect to FIG. 3.

FIG. 3 is a block diagram of a system 300 including a computing device 320 and a hearing aid 302 with an accelerometer 114. Hearing aid 302 is similar to hearing aid 102 in FIG. 1, except that hearing aid 302 further includes transceiver 316, which is adapted to communicate with computing device 320. In this illustrated example, in addition to the previously described instructions, memory 104 stores at least one hearing aid profile 306 and accelerometer detection logic 308. In some instances, transceiver 316 can be configured to send and receive data wirelessly, such as via a Bluetooth®-type, short-range wireless connection.

In some embodiments, hearing aid 302 may also include a logic circuit 318 connected to processor 110, accelerometer 114, and transceiver 316. When present, accelerometer detection functions and communication operations relating to the accelerometer can be implemented by logic circuit 318 instead of by processor 110, which may be busy processing audio signals. In a particular embodiment, logic circuit 318 can be a microprocessor.

Computing system 320 includes a processor 330 connected to a memory 324, a transceiver 332, and a touchscreen interface 334. In an alternative embodiment, the input interface and the display interface may be separated for receiving user input and for displaying information, respectively. Memory 324 includes hearing aid profiles 322, hearing aid selection logic 326, and an audio menu generator 328 that, when executed, cause processor 330 to select one or more hearing aid profiles and to generate an audio menu, which can be sent to hearing aid 102 through a communication channel. In some embodiments, computing system 320 may include a logic circuit 333, which can be connected to processor 330 and to transceiver 332. When present, logic circuit 333 may perform the accelerometer signal processing functions and pass the results to processor 330 for further processing. Depending on the implementation one or both of hearing aid 302 and computing device 320 may include the logic circuits (as shown). Alternatively, hearing aid 302 and computing device 320 may perform the operations using their respective processors 110 and 330.

In response to receiving the audio menu, hearing aid 302 utilizes accelerometer detection logic 308 to activate accelerometer 114 and to monitor electrical signals produced by accelerometer 114 in response to motion by the user. In an example, accelerometer detection logic 316 causes processor 310 to transmit the motion-related signals to computing system 320. In another example, accelerometer detection logic 316 interprets the motion-related signals and communicates data related to the input to computing system 320.

In response to receiving the signal from hearing aid 302, computing system 320 uses hearing aid profile selection logic 326 to modify a hearing aid profile, to select a hearing aid profile, or to otherwise response to the input. In one instance, the accelerometer signal corresponds to a direction and/or a rate of acceleration along an axis, and hearing aid profile selection logic 326 interprets the signal to determine the user input. In response to determining the user input, hearing aid profile selection logic 326 provides a corresponding hearing aid profile and/or an adjustment signal to hearing aid 302 to replace and/or adjust hearing aid profile 306.

Hearing aid 302 receives the signal, makes the appropriate change, and subsequently uses hearing aid profile 306 to shape sounds from microphone 308 into modulated audio signals, which can be reproduced by speaker 312.

In a particular example, the user can make selections from an audio menu supplied by, for example, a cell phone, a car stereo, a portable computing device, or some other device (that is communicatively coupled to hearing aid 302 through the communication channel) to update the hearing aid 302 and/or to make hearing aid profile selections. The accelerometer provides a “hands free” option for adjusting hearing aid 302.

In conjunction with the systems and methods described above with respect to FIGS. 1-3, a hearing aid is disclosed that includes an accelerometer that is used to detect user input for adjusting hearing aid settings. The use of the accelerometer allows for hands-free user adjustment of the hearing aid. Further, the accelerometer makes it possible for the user to selectively adjust the hearing aid without having to remove the hearing aid, without trying to manipulate small buttons on the hearing aid, and without the need for an external device.

In other embodiments, the hearing aid may be configured to communicate with a portable computing device, such as a mobile telephone or a portable computer, such as computing device 320. In such a case, hearing aid 102 may include a radio frequency transceiver (transceiver 316) adapted to communicate with a corresponding radio frequency transceiver 332 within computing device 302 through a communication channel. In this instance, user inputs received via accelerometer 114 may be provided to the computing device to retrieve settings stored in a memory of the computing device. Further, in this instance, the audio menu may be supplied to processor 110 from the computing device instead of using processor 110 to generate the audio menu within hearing aid 102.

While the above-described figures depicted a hearing aid 102 having an accelerometer to detect user input, in an alternative embodiment, the hearing aid may be replaced with a headset, ear phones, or other wearable audio devices that include an accelerometer for detecting user interaction. Such devices may also include a transceiver to communicate user input to a host device, such as a media player through wired or wireless connection. In one particular example, the user input may adjust a volume control by communicating the user input to media player, such as CD player, to adjust its volume. In such instances, the media player may include a controller responsive to the user input to make the adjustment.

Although the present invention has been described with reference to preferred embodiments, workers skilled in the art will recognize that changes may be made in form and detail without departing from the scope of the invention.

What is claimed is:

1. A hearing aid comprising:
a memory configured to store current configuration data;
an accelerometer to convert mechanical motion into a signal representing mechanical motion; and
a logic circuit coupled to the accelerometer to receive the signal and to selectively update the configuration data based on the signal.

2. The hearing aid of claim 1, further comprising a transceiver coupled to the logic circuit and configured to communicate the signal to a computing device through a communication channel.

4. The hearing aid of claim 2, wherein the accelerometer comprises a tri-axial accelerometer, and wherein the signal comprises:
a first component corresponding to the mechanical motion relative to a first axis;
a second component corresponding to the mechanical motion relative to a second axis; and
a third component corresponding to the mechanical motion relative to a third axis.

5. The hearing aid of claim 2, further comprising:
a microphone to convert sounds into sound-related signals; and
a processor coupled to the microphone and configured to apply a hearing aid profile to the sound-related signals to produce a shaped output signal, the hearing aid profile including the current configuration data.

6. The hearing aid of claim 5, wherein:
the processor is configured to provide an audio menu to the user for selecting one of the plurality of hearing aid profiles, and
the signal from the accelerometer represents a user selection related to the audio menu.

7. The hearing aid of claim 1, wherein:
the current configuration data includes directionality settings for one or more microphones; and
the logic circuit updates the directionality settings of the one or more microphones based on the signal.

8. The hearing aid of claim 1, wherein current configuration data includes a volume parameter and the logic circuit updates the volume parameter based on the signal.

9. The hearing aid of claim 1, wherein:
current configuration data includes a plurality of hearing aid profiles; and
the logic circuit selectively applies at least one of the plurality of hearing aid profiles based on the signal.

10. A method of configuring a hearing aid, the method comprising:
executing a configuration utility using a processor of the hearing aid in response to a trigger;
detecting mechanical motion using an accelerometer of the hearing aid to determine a user input to change to a hearing aid setting; and
applying the change to update a setting of the hearing aid.

11. The method of claim 10, wherein:
the configuration utility provides an audio menu including a list of user-selectable hearing aid profiles; and
the user input indicates the change corresponding to a selection of a hearing aid profiles from the list.

12. The method of claim 11, further comprising providing the audio menu a speaker of the hearing aid.

13. The method of claim 10, wherein the setting is a volume parameter.

14. The method of claim 10, wherein the setting is a pitch parameter.

15. The method of claim 10, wherein the setting is microphone parameter.

16. A wearable sound producing device comprising:
an interface to receive an audio stream from an audio source;
an accelerometer to convert mechanical motion into a signal representing of a user input;
a memory configured to store current configuration data; and
a logic circuit coupled to the accelerometer to receive the signal and coupled to the interface to communicate the user input to the audio source to adjust a parameter of the audio stream.

17. The wearable sound producing device of claim 16, wherein the parameter is a volume parameter.

18. The wearable sound producing device of claim 16, wherein the parameter is a tone parameter.

19. The wearable sound producing device of claim 16, wherein the wearable sound producing device is a hearing aid.

20. The wearable sound producing device of claim 19, wherein the configuration data includes a plurality of hearing aid profiles.
